(19) United States
(12) Patent Application Publication
(10) Pub. No.: US 2010/0259595 A1
(43) Pub. Date: Oct. 14, 2010

(54) Methods and Apparatuses for Efficient Streaming of Free View Point Video

(75) Inventors: Mejdi Ben Abdellaziz Trimeche, Tampere (FI); Imed Bouazizi, Tampere (FI); Miska Matias Hannuksela, Ruutana (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/422,182

(22) Filed: Apr. 10, 2009

(51) Int. Cl. H04N 13/00; H04N 7/173

(52) U.S. Cl. 348/43; 725/118; 348/E13.001

(57) ABSTRACT

In accordance with an example embodiment of the present invention, an apparatus comprising a processing unit configured to receive information related to available camera views of a three dimensional scene, request a synthetic view which is different from any available camera view and determined by the processing unit and receive media data comprising video data associated with the synthetic view.

### TECHNICAL FIELD

The present application relates generally to a method and apparatus for efficient streaming of free view point video.

### BACKGROUND

Continuous developments in multimedia content creation tools and display technologies pave the way towards an ever evolving multimedia experience. Multi-view video is a prominent example of advanced content creation and consumption. Multi-view video content provides a plurality of visual views of a scene. For a three-dimensional (3-D) scene, the use of multiple cameras allows the capturing of different visual perspectives of the 3-D scene from different viewpoints. Users equipped with devices capable of multi-view rendering may enjoy a richer visual experience in 3D.

Broadcasting technologies are evolving steadily with the target of enabling richer and more entertaining services. The broadcasting of high definition (HD) content is experiencing considerable progress. Scalable video coding (SVC) is being considered as an example technique to cater for the different receiver needs, enabling the efficient use of broadcast resources. A base layer (BL) may carry the video in standard definition (SD) and an enhancement layer (EL) may complement the BL to provide HD resolution. Another development in video technologies is the new standard for multi-view coding (MVC), which was designed as an extension to H.264/AVC and includes a number of new techniques for improved coding efficiency, reduced decoding complexity and new functionalities for multi-view video content.

### SUMMARY

Various aspects of the invention are set out in the claims.

In accordance with an example embodiment of the present invention, an apparatus, comprising a processing unit configured to receive information related to available camera views of a three dimensional scene, request a synthetic view which is different from any available camera view and determined by the processing unit and receive media data comprising video data associated with the synthetic view.

In accordance with an example embodiment of the present invention, a method comprises receiving information related to available camera views of a three dimensional scene, requesting a synthetic view which is different from any available camera view and determined by the processing unit and receiving media data comprising video data associated with the synthetic view.

In accordance with an example embodiment of the present invention, a computer program product comprising a computer-readable medium bearing computer program code embodied therein for use with a computer, the computer program code being configured to receive information related to available camera views of a three dimensional scene, request a synthetic view which is different from any available camera view and determined by the processing unit and receive media data comprising video data associated with the synthetic view.

In accordance with an example embodiment of the present invention, an apparatus, comprising a processing unit configured to send information related to available camera views of a three dimensional scene, receive, from a user equipment, request for a synthetic view, which is different from any available camera view, and transmit media data, the media data comprising video data associated with siad synthetic view.

In accordance with an example embodiment of the present invention, a method comprising sending information related to available camera views of a three dimensional scene, receiving, from a user equipment, request for a synthetic view, which is different from any available camera view, and transmitting media data, the media data comprising video data associated with siad synthetic view.

In accordance with an example embodiment of the present invention, a computer program product comprising a computer-readable medium bearing computer program code embodied therein for use with a computer, the computer program code being configured to send information related to available camera views of a three dimensional scene, receive from a user equipment request for a synthetic view, which is different from any available camera view, and transmit media data, the media data comprising video data associated with siad synthetic view.

### BRIEF DESCRIPTION OF THE DRAWINGS

For a more complete understanding of example embodiments of the present invention, the objects and potential advantages thereof, reference is now made to the following descriptions taken in connection with the accompanying drawings in which:

FIG. 1 is a diagram of an example multi-view video capturing system in accordance with an example embodiment of the invention;

FIG. 2 is an diagram of an example video distribution system operating in accordance with an example embodiment of the invention;

FIG. 3a illustrates an example of a synthetic view spanning across multiple camera views in an example multi-view video capturing system;

FIG. 3b illustrates an example of a synthetic view spanning across a single camera view in an example multi-view video capturing system;

FIG. 4a illustrates a block diagram of a video processing server;

FIG. 4b is a block diagram of an example streaming server;

FIG. 4c is a block diagram of an example user equipment;

FIG. 5a shows a block diagram illustrating a method performed by a user equipment according to an example embodiment;

FIG. 5b shows a block diagram illustrating a method performed by the streaming server according to an example embodiment;

FIG. 6a shows a block diagram illustrating a method performed by a user equipment according to another example embodiment;

FIG. 6b shows a block diagram illustrating a method performed by a streaming server according to another example embodiment;

FIG. 7 illustrates an example embodiment of scene navigation from one active view to a new requested view; and

FIG. 8 illustrates an example embodiment of scalable video data streaming from the streaming server to user equipment.

### DETAILED DESCRIPTION OF THE DRAWINGS

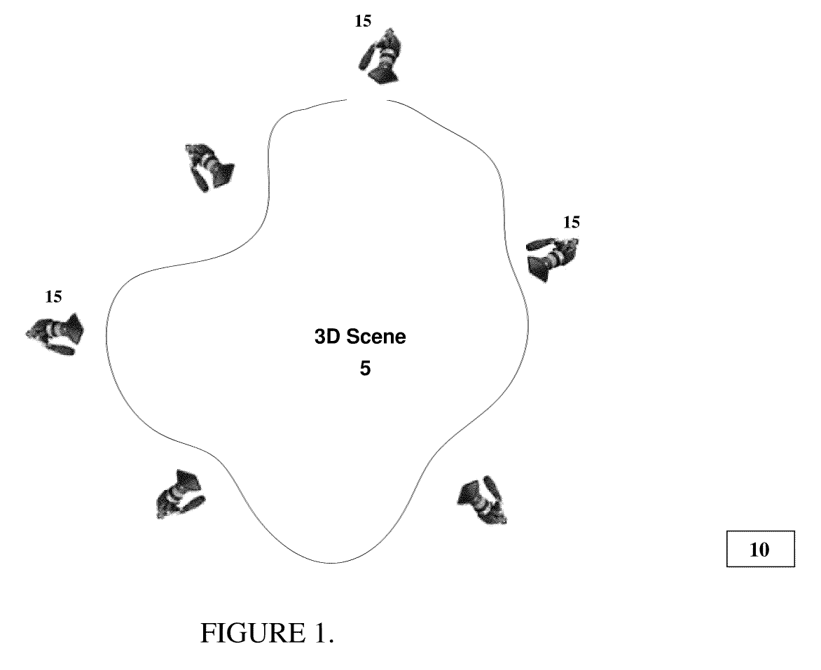

An example embodiment of the present invention and its potential advantages are best understood by referring to FIGS. 1 through 8 of the drawings, like numerals being used for like and corresponding parts of the various drawings.

FIG. 1 is a diagram of an example multi-view video capturing system 10 in accordance with an example embodiment of the invention. The multi-view video capturing system 10 comprises multiple cameras 15. In the example of FIG. 1, each camera 15 is positioned at different viewpoints around a three-dimensional (3-D) scene 5 of interest. A viewpoint is defined based at least in part on the position and orientation of the corresponding camera with respect to the 3-D scene 5. Each camera 15 provides a separate view, or perspective, of the 3-D scene 5. The multi-view video capturing system 10 simultaneously captures multiple distinct views of the same 3-D scene 5.

Advanced rendering technology may support free view selection and scene navigation. For example, a user receiving multi-view video content may select a view of the 3-D scene for viewing on his/her rendering device. A user may also decide to change from one view, being played to a different view. View selection and view navigation may be applicable among viewpoints corresponding to cameras of the capturing system 10, e.g., camera views. According to at least an example embodiment of the present invention, view selection and/or view navigation comprise the selection and/or navoigation of synthetic views. For example the user may navigate the 3D scene using his remote control device or a joystick and can change the view by pressing specific keys that serve as incremental steps to pan, change perspective, rotate, zoom in or zoom out of the scene. It should be understood that example embodiments of the invention are not limited to a particular user interface or interaction method and it is implied that the user input to navigate the 3D scene may be interpreted into geometric parameters which are independent of the user interface or interaction method.

The support of free view television (TV) applications, e.g. view selection and navigation, comprises streaming of multi-view video data and signaling of related information. Different users, of a free view TV video application, may request different views. To make an intuitive system for view selection and/or view navigation, an end-user device takes advantage of an available description of the scene geometry. The end-user device may further use any other information that is associated with available camera views, in particular the geometry information that relates the different camera views to each other. The information, relating the different camera views to each other, is preferably summarized into few geometric parameters that are easily transmitted to a video server. The camera views information may also relate the camera views to each other using optical flow matrices that define the relative displacement between the views at every pixel position.

Allowing an end-user to select and play back a synthetic view offers the user a richer and more personalized free view TV experience. One challenge, related to the selection of a synthetic view, is how to define the synthetic view. Another challenge is how to identify camera views sufficient to construct, or generate, the synthetic view. Efficient streaming of the sufficient minimum set of video data to construct the selected synthetic view at a receiving device is one more challenge.

Example embodiments described in this application disclose a system and methods for distributing multi-view video content and enabling free view TV and/or video applications. The streaming of multiple video data streams, e.g., corresponding to available camera views, may significantly consume the available network resources. According to at least one example embodiment of this application, an end-user may select a synthetic view, i.e., a view not corresponding to one of the available camera views of the video capturing system 10. A synthetic view may be constructed or generated by processing one or more camera views.

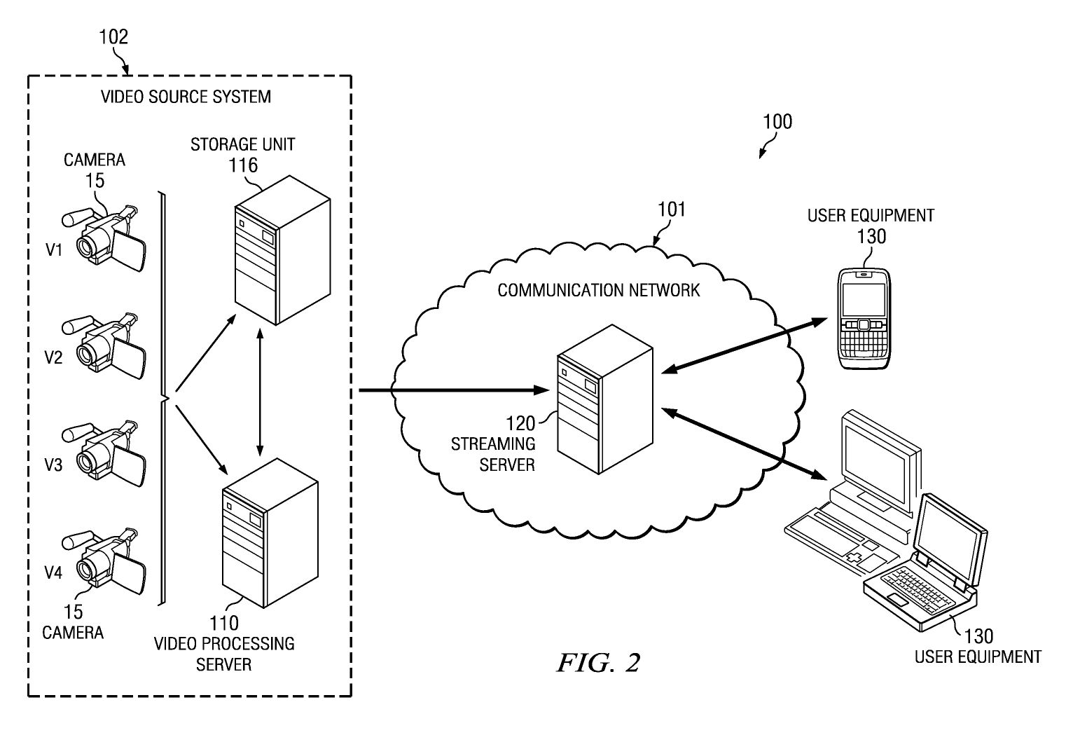

FIG. 2 is a diagram of an example video distribution system 100 operating in accordance with an example embodiment of the invention. In an example embodiment, the video distribution system comprises a video source system 102 connected through a communication network 101 to at least one user equipment 130. The communication network 101 comprises a streaming server 120 configured to stream multi-view video data to at least one user equipment 130. The user equipments have access to the communication network 101 via wire or wireless links. In an example embodiment, one or more user equipments are further coupled to video rendering devices such as a HD TV set, a display screen and/or the like. The video source system 102 transmitts video content to one or more clients, residing in one or more user equipment, through the communication network 101. A user equipment 130 may play back the received content on its display or on a rendering device with wire, or wireless, coupling to the receiving user equipment 130. Examples of user equipments comprise a laptop, a desktop, a mobile phone, TV set, and/or the like.

In an example embodiment, the video source system 102 comprises a multi-view video capturing system 10, comprising multiple cameras 15, a video processing server 110 and a storage unit 116. Each camera 15 captures a separate view of the 3D scene 5. Multiple views captured by the cameras may differ based on the locations of the cameras, the focal directions/orientations of the cameras, and/or their adjustments, e.g., zoom. The multiple views are encoded into either a single compressed video stream or plurality of compressed video streams. For example, the video compression is performed by the processing server 110 or within the capturing cameras. According to an example embodiment, each compressed video stream corresponds to a separate captured view of the 3D scene. According to an alternative example embodiment a compressed video stream may correspond to more than one camera view. For example, multi-view video coding (MVC) standard is used to compress more than one camera view into a single video stream.

In an example embodiment, the storage unit 116 may be used to store compressed and/or non-compressed video data. In an example embodiment, the video processing server 110 and the storage unit 116 are different physical entities coupled through at least one communication interface. In another example embodiment, the storage unit 116 is a component of the video processing server 110.

In an example embodiment, the video processing server 110 calculates at least one scene depth map or image. A scene depth map, or image, provides information about the distance between a capturing camera 15 and one or more points in the captured scene 5. In an alternative embodiment, the scene depth maps are calculated by the cameras. For example, each camera 15 calculates a scene depth map associated with a scene or view captured by the same camera 15. In an example embodiment, a camera 15 calculates a scene depth map based at least in part on sensor data.

For example, the depth maps can be calculated by estimating the stereo correspondences between two or more camera views. The disparity maps obtained using stereo correspondence may be used together with the extrinsic and intrinsic camera calibration data to reconstruct an approximation of the depth map of the scene for each video frame. In an embodiment, the video processing server 110 generates relative view geometry. The relative view geometry describes, for example, the relative locations, orientations and/or settings of the cameras. The relative view geometry provides information on the relative positioning of each camera and/or information on the different projection planes, or view fields, associated with each camera 15.

In an example embodiment, the processing server 110 maintains and updates information describing the cameras' locations, focal orientations, adjustments/settings, and/or the like throughout the capturing process of the 3D scene 5. In an example embodiment, the relative view geometry is derived using a precise camera calibration process. The calibration process comprises determining a set of intrinsic and extrinsic camera parameters. The intrinsic parameters relate the internal placement of the sensor with respect to the lenses and to a center of origin, whereas the extrinsic parameters relate the relative camera positioning to an external coordinate system of the imaged scene. In an example embodiment, the calibration parameters of the camera are stored and transmitted. Also, the relative view geometry may be generated, based at least in part on sensors' information associated with the different cameras 15, scene analysis of the different views, human input from people managing the capturing system 10 and/or any other system providing information on cameras' locations, orientations and/or settings. Information comprising scene depth maps, relative view information and/or camera parameters may be stored in the storage unit 116 and/or the video processing server 110.

A streaming server 120 transmits compressed video streams to one or more clients residing in one or more user equipments 130. In the example of FIG. 2, the streaming server 120 is located in the communication network 101. The streaming of compressed video content, to user equipments, is performed according to unicast, multicast, broadcast and/or other streaming method.

Various example embodiments in this application describe a system and methods for streaming multi-view video content. In an example embodiment, scene depth maps and/or relative geometry between available camera views are used to offer end-users the possibility of requesting and experiencing user-defined synthetic views. Synthetic views do not necessarily coincide with available camera views, e.g., corresponding to capturing cameras 1.

Depth information may also be used in some rendering techniques, e.g., depth-image based rendering (DIBR) to construct a synthetic view from a desired viewpoint. The depth maps associated with each available camera view provide per-pixel information that is used to perform 3-D image warping. The extrinsic parameters specifying the positions and orientations of existing cameras, together with the depth information and the desired position for the synthetic view can provide accurate geometry correspondences between any pixel points in the synthetic view and the pixel points in the existing camera views. For each grid point on the synthetic view, the pixel color value assigned to the grid point is determined. Determining pixel color values may be implemented using a variety of techniques for image resampling, for example, while simultaneously solving for the visibility and occlusions in the scene. To solve for visibility and occlusions, other supplementary information such as occlusion textures, occlusion depth maps and transparency layers from the available camera views are employed to improve the quality of the synthesized views and to minimize the artifacts therein. It should be understood that example embodiments of the invention are not restricted to a specific technique for image based rendering or any other techniques for view synthesis.

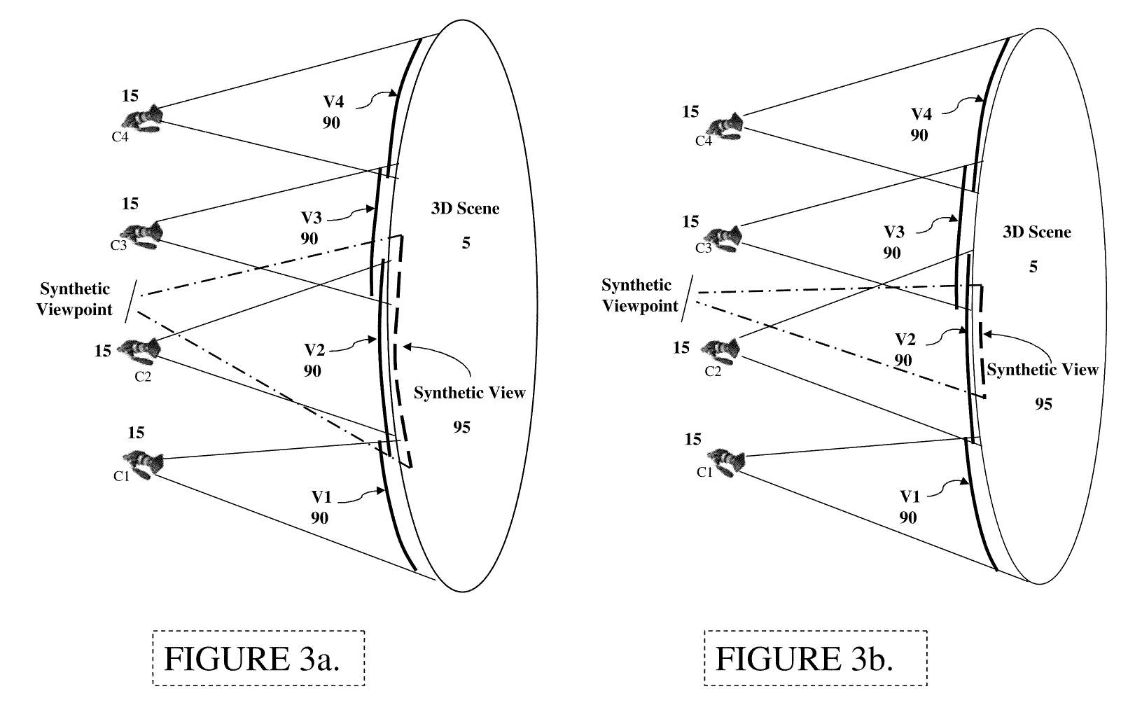

FIG. 3a illustrates an example of a synthetic view 95 spanning across multiple camera views 90 in an example multi-view video capturing system 10. The multi-view video capturing system 10 comprises four cameras, indexed as C1, C2, C3 and C4, with four corresponding camera views 90, indexed as V1, V2, V3 and V4, of the 3-D scene 5. The synthetic view 95 may be viewed as a view with a synthetic or virtual viewpoint, e.g., where no corresponding camera is located. The synthetic view 95, comprises the camera view indexed as V2, part of the camera view indexed as V1 and part of the camera view indexed as V3. Restated, the synthetic view 95 may be constructed using video data associated with the camera views indexed V1, V2 and V3. An example construction method, of the synthetic view 95, comprises cropping the relevant parts in the camera views indexed as V1 and V3 and merging the cropped parts with the camera view indexed as V2 into a single view. Other processing techniques may be applied in constructing the synthetic view 95.

FIG. 3b illustrates an example of a synthetic view 95 spanning across a single camera view in an example multi-view video capturing system 10. According to an example embodiment, the multi-view video capturing system 10 comprises four cameras, indexed as C1, C2, C3 and C4, with four corresponding camera views 90, indexed as V1, V2, V3 and V4, of the 3-D scene 5. The synthetic view 95 described in FIG. 3b spans only a part of the camera view indexed as V2. Given the video data associated with the camera view indexed as V2, the synthetic view 95 in FIG. 3b may be constructed, for example, using image cropping methods and/or image retargeting techniques. Other processing methods may be used, for example, in the compressed domain or in the spatial domain.

According to an example embodiment, the minimum subset of existing views to reconstruct the requested synthetic view is determined to minimize the network usage. For example, the synthetic view 95 in FIG. 3a may be constructed either using the first subset consisting of camera views V1, V2 and V3 or using a second subset consisting of views V2 and V3. The second subset is selected because it requires less bandwidth to transmit the video and less memory to generate the synthetic view. According to an example embodiment, a precomputed table of such minimum subsets to reconstruct a set of discrete positions corresponding to synthetic views is determined to avoid performing the computation each time a synthetic view is requested.

In the context of free view interactive TV applications, several scenarios may be considered. For example, the multi-view video data, corresponding to different camera views 90, may be jointly encoded using a multi-view video coding (MVC) encoder, or codec. According to an example embodiment, video data corresponding to different camera views 90 are independently encoded, or compressed, into multiple video streams. According to an example embodiment of this application, the availability of multiple different video streams allows the delivery of different video content to different user equipments 130 based, for example, on the users' requests. In yet another possible scenario, different subsets of the available camera views 90 data are jointly compressed using MVC codecs. For example, a compressed video stream may comprise data associated with two or more overlapping camera views 90.

According to an example embodiment, the 3-D scene 5 is captured by sparse camera views 90 that have overlapping fields of view. The 3-D scene depth map(s) and relative geometry is calculated based at least in part on the available camera views 90 and/or cameras' information, e.g., positions, orientations and settings. Information related to scene depth and/or relative geometry is provided to the streaming server 120. User equipment 130 may be connected to the streaming server 120 through a feedback channel to request a synthetic view 95.

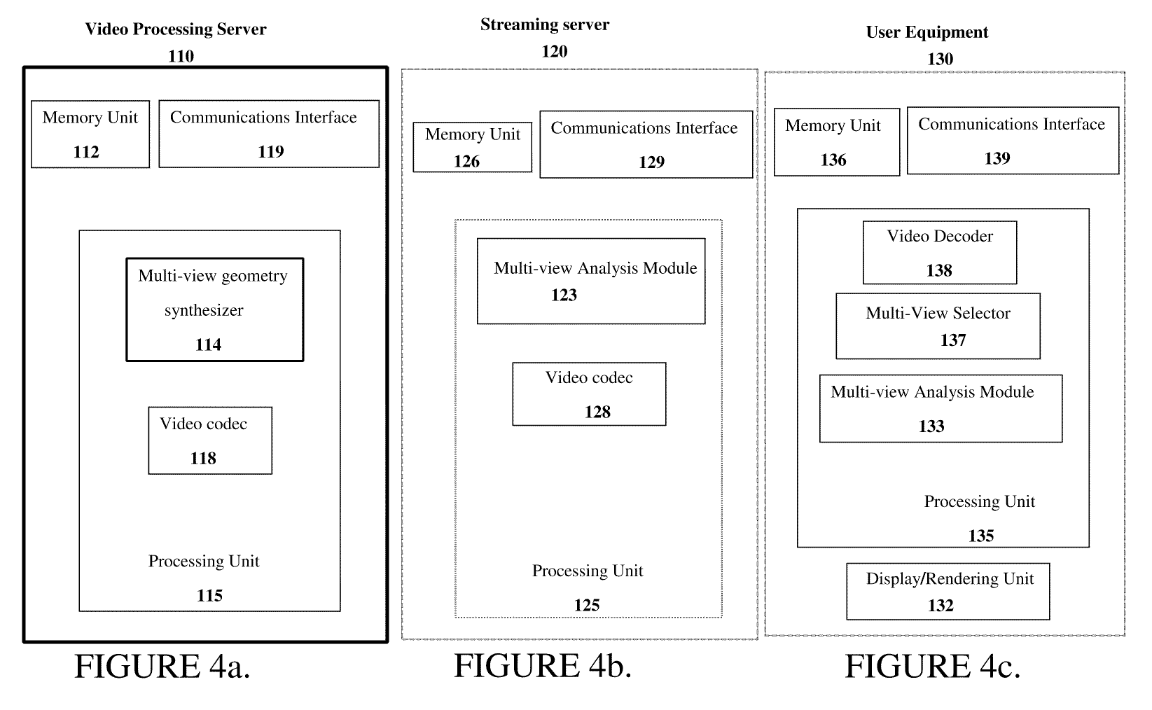

FIG. 4a illustrates a block diagram of a video processing server 110. According to an example embodiment, the video processing server 110 comprises a processing unit 115, a memory unit 112 and at least one communication interface 119. The video processing server 110 further comprises a multi-view geometry synthesizer 114 and at least one video encoder, or codec, 118. The multi-view geometry synthesizer 114, the video codec(s) 118 and/or the at least one communication interface 119 may be implemented as software, hardware, firmware and/or a combination of more than one of software, hardware and firmware. According to the example embodiment of FIG. 4a, functionalities associated with the geometry synthesizer 114 and the video codec(s) 118 are executed by the processing unit 115. The processing unit 115 comprises one or more processors and/or processing circuitries.

The multi-view geometry synthesizer 114 generates, updates and/or maintains information related to relative geometry of different camera views 90. According to an example embodiment, the multi-view geometry synthesizer 114 calculates a relative geometry scheme. The relative geometry scheme describes, for example, the boundaries of optical fields associated with each camera view. In an alternative example embodiment, the relative geometry scheme may describe the location, orientation and settings of each camera 15. The relative geometry scheme may further describe the location of the 3-D scene 5 with respect to the cameras. The multi-view geometry synthesizer 114 calculates the relative geometry scheme based, at least in part, on calculated scene depth maps and/or other information related to the locations, orientations and settings of the cameras. According to an example embodiment, the scene depth maps are generated by the cameras, using for example some sensor information, and then are sent to the video processing server 110. The scene depth maps, in an alternative example embodiment, are calculated by the multi-view geometry synthesizer 114. Cameras' locations, orientations and other settings forming the intrinsic and extrinsic calibration data may also be provided to the video processing server 110, for example, by each camera 15 automatically or provided as input by a person, or a system, managing the video source system. The relative geometry scheme and the scene depth maps provide sufficient information for end-users to make cognizant selection of, and/or navigation through, camera and synthetic views.

The video processing server 110, according to an example embodiment, receives compressed video streams from the cameras. In another example embodiment, the video processing server 110 receives, from the cameras or the storage unit, uncompressed video data and encodes it into one or more video streams using the video codec(s) 118. Video codec(s) 118 use, for example, information associated with the relative geometry and/or scene depth maps in compressing video streams. For example, if compressing video content associated with more than one camera view in a single stream, knowledge of overlapping regions in different views helps in achieving efficient compression. Uncompressed video streams are sent from cameras to the video processing server 110 or to the storage unit 116. Compressed video streams are stored in the storage unit 116. Compressed video streams are transmitted to the streaming server 120 via the communication interface 119 of the video processing server 110. Examples of video codecs 118 comprise an advanced video coding (AVC) codec, multi-view video coding (MVC) codec, scalable video coding (SVC) codec and/or the like.

FIG. 4b is a block diagram of an example streaming server 120. The streaming server 120 comprises a processing unit 125, a memory unit 126 and a communications interface 129. The video streaming server 120 may further comprise one or more video codecs 128 and/or a multi-view analysis module 123. Examples of video codecs 128 comprise an advanced video coding (AVC) codec, multi-view video coding (MVC) codec, scalable video coding (SVC) codec and/or the like. The video codec(s) 128, for example, decodes compressed video streams, received from the video processing server 110, and encodes them into a different format. For example, the video codec(s) acts as transcoder(s) allowing the streaming server 110 to receive video streams in one or more compressed video formats and transmit the received video data in another compressed video format based, for example, on the capabilities of the video source system 102 and/or the capabilities of receiving user equipments. The multi-view analysis module 123 identifies at least one camera view sufficient to construct a synthetic view 95. The identification, in an example, is based at least in part on the relative geometry and/or scene depth maps received from the video processing server 110. The identification of camera views, in an alternative example, is based at least in part on at least one transformation describing, ofr example, overlapping regions between different camera and/or synthetic views. Depending on whether or not the streaming server 110 identifies camera views 90, associated with a synthetic view 95, the streaming server may or may not comprise a multi-view analysis module 123. In an example embodiment the multi-view analysis module 123, the video codec(s) 128, and/or the communications interface 129 may be implemented as software, hardware, firmware and/or a combination of more than one of software, hardware and firmware. According to the example embodiment of FIG. 4b, functionalities associated with the video codec(s) 128 and the multi-view analysis module 123 are executed by the processing unit 125. The processing unit 125 comprises one or more processors and/or processing circuitry. The processing unit is communicatively coupled to the memory unit 126, the communications interface 129 and/or other hardware components of the streaming server 120.

The streaming server 120 receives, via the communications interface 129, compressed video data, scene depth maps and/or the relative geometry scheme. The compressed video data, scene depth maps and the relative geometry scheme may be stored in the memory unit 126. The streaming server 120 forwards scene depth maps and/or the relative geometry scheme, via the communications interface 129, to one or more user equipments 130. The streaming server also transmits compressed multi-view video data to one or more user equipments 130.

FIG. 4c is an example block diagram of a user equipment 130. The user equipment 130 comprises a communications interface 139, a memory unit 136 and a processing unit 135. The user equipment 130 further comprises at least one video decoder 138 for decoding received video streams. Examples of video decoders 138 comprise an advanced video coding (AVC) decoder, multi-view video coding (MVC) decoder, scalable video coding (SVC) decoder and/or the like. The user equipment 130 comprises a display/rendering unit 132 for displaying information and/or video content to the user. The processing unit 135 comprises at least one processor and/or processing circuitries. The processing unit 135 is communicatively coupled to the memory unit 136, the communications interface 139 and/or other hardware components of the user equipment 130. The user equipment 130 further comprises a multi-view selector. The user equipment 130 may further comprise a multi-view analysis module 133.

According to an example embodiment, the user equipment 130 receives scene depth maps and/or the related geometry scheme, via the communications interface 139, from the streaming server 120. The multi-view selector 137 allows the user to select a preferred synthetic view 95. The multi-view selector 137 comprises a user interface to present, to the user, information related to available camera views 90 and/or cameras. The presented information allows the user to make a cognizant selection of a preferred synthetic view 95. For example, the presented information comprises information related to the relative geometry scheme, the scene depth maps and/or snapshots of the available camera views. The multi-view selector 137 may be further configured to store the user selection.

In an example embodiment, the processing unit 135 sends the user selection, to the streaming server 120, as parameters, or a scheme, describing the preferred synthetic view 95. The multi-view analysis module 133 identifies a set of camera views 90 associated with the selected synthetic view 95. The identification may be based at least in part on information received from the streaming server 120. The processing unit 135 then sends a request for the streaming server 120 requesting video data associated with identified camera views 90.

The processing unit 135 receives video data from the streaming server 120. Video data is then decoded using the video decoder(s) 138. The processing unit 135 displays the decoded video data on the display/rendering unit 132 and/or sends it to another rendering device coupled to the user equipment 130. The video decoder(s) 138, multi-view selector module 137 and/or the multi-view analysis module 133 may be implemented as as software, hardware, firmware and/or a combination of software, hardware and firmware. In the example embodiment of FIG. 4c, processes associated with the video decoder(s) 138, multi-view selector module 137 and/or the multi-view analysis module 133 are executed by the processing unit 135.

According to various embodiments, the streaming of multi-view video data may be performed using a streaming method comprising unicast, multicast, broadcast and/or the like. The choice of the streaming method used depends at least in part on one of the factors comprising the characteristics of the service through which the multi-view video data is offered, the network capabilities, the capabilities of the user equipment 130, the location of the user equipment 130, the number of the user equipments 130 requesting/receiving the multi-view video data and/or the like.

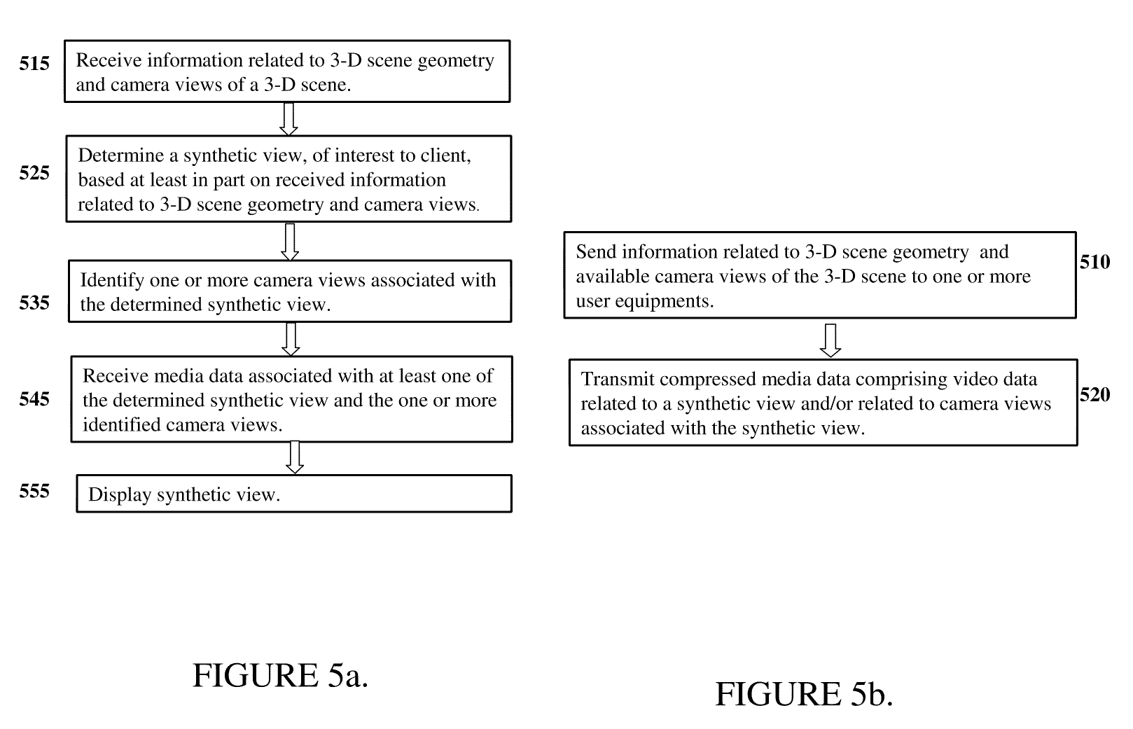

FIG. 5a shows a block diagram illustrating a method performed by a user equipment 130 according to an example embodiment. At 515, information related to scene geometry and/or camera views of a 3D scene is received by the user equipment 130. The received information, for example, comprises one or more scene depth maps and a relative geometry scheme. The received information provides a description of the available camera views, the relative positions, orientations and settings of the cameras and/or the like. At 525, a synthetic view 95 of interest is selected by the user equipment 130 based at least in part on the received information. The relative geometry and/or camera views information is displayed to the user. The user may, for example, indicate the selected synthetic view by specifying a location, orientation and settings of a virtual camera. In another example, the user indicates the boundaries of the synthetic view of interest based, at least in part, on displayed snapshots of available camera views 90 and a user interface.

The user interface allows the user to select a region across one or more camera views 90, for example, via a touch screen. Additionally, the user may use a touch screen interface for example to pan or fly in the scene by simply dragging his finger in the desired direction and synthesize new views in a predictive manner by using the detected finger motion and acceleration. Another interaction method with the video scene may be implemented using a multi touch device wherein the user can use two or more fingers to indicate a combined effect of rotation or zoom, etc. Yet in another example, the user may navigate the 3D scene using a remote control device or a joystick and can change the view by pressing specific keys that serve as incremental steps to pan, change perspective, rotate, zoom in or zoom out to generate synthetic views with smooth transition effects. It is implied through these different examples that the invention is not limited to a particular user interface or interaction method as long as the user input is summarized into specific geometry parameters that can be used to synthesize new views and or intermediate views that can be used to generate smooth transition effects between the views. According to an example embodiment, calculation of the geometry parameters corresponding to the synthetic view, e.g., coordinates of synthetic view with respect to camera views, may be further performed by the multi-view selector 137.

The user equipment 130 comprises a multi-view analysis module 133 and at 535 one or more camera views 90 associated with the determined synthetic view 95 are determined by the multi-view analysis module 133. The identified one or more camera views 90 serve to construct the determined synthetic view 95. According to a preferred embodiment, the identified camera views 90 constitute a smallest set of camera views, e.g., with the minimum number possible of camera views, sufficient to construct the determined synthetic view 95. One advantage of the minimization of the number of identified camera views is the efficient use of network resources, for example, when using unicast and/or multicast streaming methods. For example, in FIG. 3a the smallest set of camera views sufficient to construct the synthetic view 95 comprises the views V1, V2 and V3. In FIG. 3b, the identified smallest set of camera views comprises the camera view V2. In another example embodiment, the multi-view analysis module 133 may identify a set of camera views based on different criteria. For example, the multi-view analysis module 133 may take into account the image quality and/or the luminance of each camera view 90. In FIG. 3b, the multi-view analysis module may identify views V2 and V3 instead of only V2. For example, the use of V3 with V2 may improve the video quality of the determined synthetic view 95.

At 545, media data associated with at least one of the determined synthetic views 95 and/or the one or more identified camera views is received by the user equipment 130. In an example broadcast scenario, the user equipment 130 receives compressed video streams associated with all available camera views 90. The user equipment 130, then decodes only video streames associated with the identified camera views. In an example scenario where media data is received in a unicast streaming session, the user equipment 130 sends information about identified camera views to the streaming server 120. The user equipment 130, receives in response to sent information one or more compressed video streams associated with the identified camera views 90. The user equipment 130 may also send information about the determined synthetic view 95 to the streaming server 120. The streaming server 120 constructs the determined synthetic view based, at least in part, on the received information and transmits a compressed video stream associated with the synthetic view 95 determined at the user equipment 130. The user equipment 130 receives the compressed video stream and decodes it at the video decoder 138.

In the case of multicast streaming of media data to receiving devices, the streaming server 120 transmits, for example, each media stream associated with a camera view 90 in a single multicasting session. The user equipment 130, subscribes to the multicasting sessions associated with the camera views identified by the multi-view analysis module 133 in order to receive video streams corresponding to the identified camera views. In another multicasting scenario, user equipments may send information about their determined synthetic views 95 and/or identified camera views to the streaming server 120. The streaming server 120 transmits multiple video streams associated with camera views commonly identified by most of, or all, receiving user equipments in a single multicasting session. Video streams associated with camera views identified by a single or few user equipments may be transmitted in a unicast sessions to the the corresponding user equipments; this may require additional signaling schemes to synchronize the dynamic streaming configurations but may also save significant bandwidth since it can be expected that most users will follow stereotyped patterns of view point changes. In another example, the streaming server 120 decides, based at least in part on the received information, on few synthetic views 95 to be transmitted in one or more multicasting sessions. Each user equipment 130, then subscribes to the multicasting session associated with the synthetic 95 view closest to the one determined by the same user equipment 130. User equipment 130, decodes received video data at the video decoder 138.

At 555, the synthetic view 95 is displayed by the user equipment 130. The user equipment 130 may display video data on its display 132 or on a visual display device coupled to the user equipment 130, e.g., HD TV, a digital projector, a 3-D display equipment, and/or the like. In the case where the user equipment 130 receives video streams associated with identified camera views, further processing is performed by the processing unit 135 of the user equipment 130 to construct the determined synthetic view from the received video data.

FIG. 5b shows a block diagram illustrating a method performed by the streaming server 120 according to an example embodiment. At 510, information related to scene geometry and/or available camera views 90 of the 3-D scene 5 is transmitted by the streaming server 120 to one or more user equipments. The transmitted information, for example, comprises one or more scene depth maps and a relative geometry scheme. The transmitted information provides a description of the available camera views, the relative positions, orientations and settings of the cameras and/or the 3-D scene geometry. At 520, media data comprising video data, related to a synthetic view and/or related to camera views associated with the synthetic view 95, is transmitted by the streaming server 120. In a broadcasting scenario, for example, the streaming server 120 broadcasts video data related to available camera views 90. Receiving user equipments, then choose the video streams that are relevant to their determined synthetic view 95. Further processing is performed by the processing unit 135 of the user equipment 130 to construct the determined synthetic view using the previously identified relevant video streams.

In a multicasting scenario, the streaming server 120 transmits each video stream associated with a camera view 90 in a single multicasting session. A user equipment 130 may then subscribe to the multicasting sessions with video streams corresponding to the identified camera views by the same user equipment 130. In another example multicasting scenario, the streaming server 120 further receives information, from user equipments, about identified camera views and/or corresponding determined synthetic views by the user equipments. Based at least in part on the received information, the streaming server 120 performs optimization calculations and determines a set of camera views that are common to all, or most of the, receiving user equipments and multicast only those views. In yet another example, the streaming server 120 may group multiple video streams in a multicasting session. The streaming server 120 may also generate one or more synthetic views, based on the received information, and transmit the video stream for each generated synthetic view in a multicasting session. The generated synthetic views at the streaming server 120 may be generated, for example, in a way to accomodate the determined synthetic views 95 by the user equipments while reducing the amount of video data multicasted by the streaming server 120. The generated synthetic views may be, for example, identical to, or slightly different than, one or more of the determined synthetic views by the user equipments.

In a unicast scenario, the streaming server 120 further receives information, from user equipments, about identified camera views and/or corresponding determined synthetic views by the user equipments. At 520, the corresponding requested camera views are transmitted by the streaming server 120 to one or more user equipments. The streaming server 120 may also generate a video stream for each synthetic view 95 determined by a user equipment. At 520, the generated streams are then transmitted to the corresponding user equipments. In this case, the received video streams do not require any further geometric processing and can be directly shown to the user.

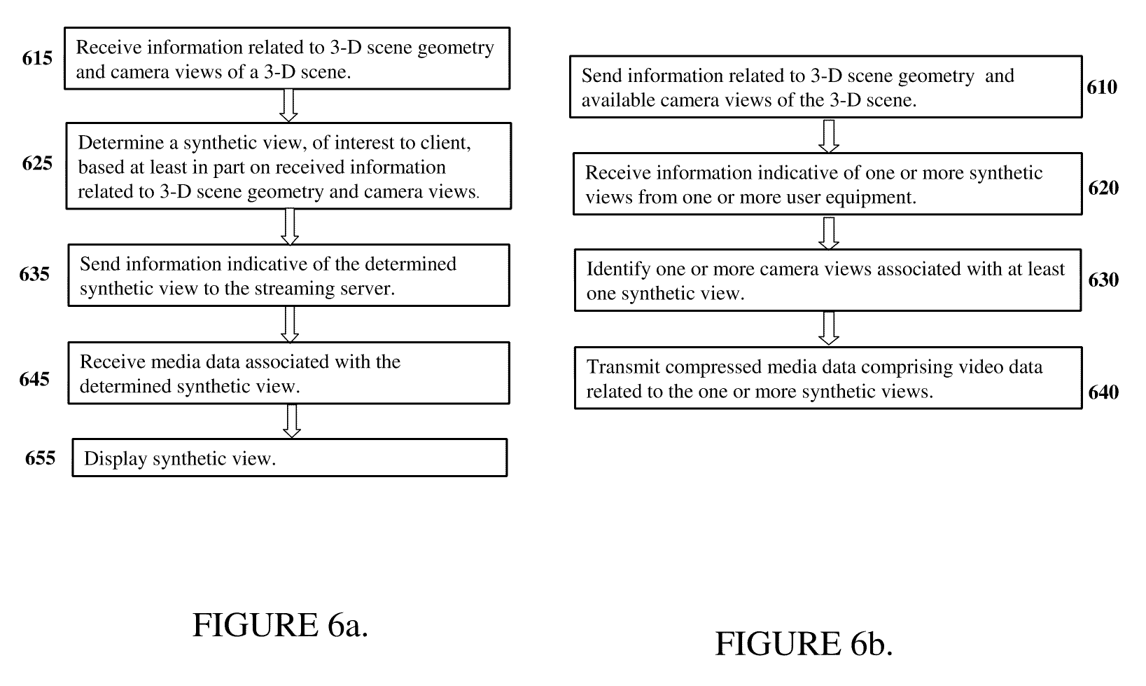

FIG. 6a shows a block diagram illustrating a method performed by a user equipment 130 according to another example embodiment. At 615, information related to scene geometry and/or camera views of the scene is received by the user equipment 130. The received information, for example, comprises one or more scene depth maps and a relative geometry scheme. The received information provides a description of the available camera views, the relative positions, orientations and settings of the cameras and/or the like. At 625, a synthetic view 95 of interest is selected, for example by a user of a user equipment 130, based at least in part, on the received information. The relative geometry and/or camera views information is displayed to the user. The user may, for example, indicate the selected synthetic view by specifying a location, orientation and settings of a virtual camera. In another example, the user indicates the boundaries of the synthetic view of interest based, at least in part, on displayed snapshots of available camera views 90 and a user interface. The user interface allows the user to select a region across one or more camera views 90, for example, via a touch screen. Additionally, the user may use a touch screen interface for example to pan or fly in the scene by simply dragging his finger in the desired direction and synthesize new views in a predictive manner by using the detected finger motion and acceleration. Another interaction method with the video scene is implemented, for example, using a multi touch device wherein the user can use two or more fingers to indicate a combined effect of rotation or zoom, etc. Yet in another example, the user navigates the 3-D scene using a remote control device or a joystick and changes the view by pressing specific keys that serve as incremental steps to pan, change perspective, rotate, zoom in or zoom out to generate synthetic views with smooth transition effects. It is implied through these different examples that the invention is not limited to a particular user interface or interaction method. User input is summarized into specific geometry parameters that are used to synthesize new views and or intermediate views that may be used to generate smooth transition effects between the views. According to an example embodiment, calculation of the geometry parameters corresponding to the synthetic view, e.g., coordinates of synthetic view with respect to camera views, may be further performed by the multi-view selector 137. At 635, information indicative of the determined synthetic view 95, is sent by the user equipment 130 to the streaming server 120. The information sent comprises coordinates of the determined synthetic view, e.g., with respect to coordinates of available camera views 90, and/or paramters of a hypothetical camera that would capture the determined synthetic view 95. The parameters comprise location, orientation and/or settings of of the hypothetical camera.

At 645, media data, comprising video data associated with the determined synthetic view, is received by the user equipment 130. In an example unicast scenario, the user equipment 130 receives a video stream associated with the determined synthetic view 95. The user equipment 130 decodes the received video stream to get the non-compressed video content of the determined synthetic view. In another example, the user equipment receives a bundle of video streams associated with one or more camera views sufficient to reconstruct the determined synthetic view 95. The one or more camera views are identified at the streaming server 120. The user equipment 130 decodes the received video streams and reconstructs the determined synthetic view 95.

In an example multicasting scenario, the user equipment 130 subscribes to one or more multicasting sessions to receive one or more video streams. The one or more video streams may be associated with the determined synthetic view 95 and/or with camera views identified by the streaming server 120. The user equipment 130 may further receive information indicating which multicasting session(s) is/are relavant to the user equipment 130.

At 655, decoded data video is displayed by the user equipment 130 on its own display 132 or on a visual display device coupled to the user equipment 130, e.g., HD TV, a digital projector, and/or the like. In the case where the user equipment 130 receives video streams associated with identified camera views, further processing is performed by the processing unit 135 to construct the determined synthetic view from the received video data.

FIG. 6b shows a block diagram illustrating a method performed by a streaming server 120 according to another example embodiment. At 610, information related to scene geometry and/or available camera views 90 of the scene is transmitted by the streaming server 120 to one or more user equipments 130. The transmitted information, for example, comprises one or more scene depth maps and/or a relative geometry scheme. The transmitted information provides a description of the available camera views, the relative positions, orientations and settings of the cameras and/or the 3D scene geometry. At 520, information indicative of one or more synthetic views, is received buy the streaming server 120 from one or more user equipments. The synthetic views are determined at the one or more user equipments. The received information comprises, for example, coordinates of the synthetic views, e.g., with respect to coordinates of available camera views. In another example, the received information may comprise parameters for location, orientation and settings of one or more virtual cameras. At 630, the streaming server 120 identifies one or more camera views associated with at least one synthetic view 95. For example, for each synthetic view 95 the streaming server 120 identifies a set of camera views to reconstruct the same synthetic view 95. The identification of camera views is performed by the multi-view analysis module 123.

At 640, media data comprising video data related to the one or more synthetic views is transmitted by the streaming server 120. According to an example embodiment, the streaming server transmits, to a user equipment 130 interested in a synthetic view, the video streams corresponding to identified camera views for the same synthetic view. In another example embodiment, the streaming server 120 constructs the synthetic view indicated by the user equipment 130 and generates a corresponding compressed video stream. The generated compressed video stream is then transmitted to the user equipment 130. The streaming server 120 may, for example, construct all indicated synthetic views and generate the corresponding video streams and transmit them to the corresponding user equipments. The streaming server 120 may also construct one or more synthetic views that may or may not be indicated by user equipments. For example, the streaming server 120 may choose to generate and transmit a number of synthetic views that is less than the number of indicated synthetic views by the user equipments. One or more user equipments 130 may receive video data for a synthetic view that is different than what is indicated by the same one or more user equipments.

In an example embodiment, the streaming server 120 uses unicast streaming to deliver video streams to the user equipments. In a unicast scenario, the streaming server 120 transmits, to a user equipment 130, video data related to a synthetic view 95 indicated by the same user equipment. In an alternative example embodiment, the streaming server 120 broadcasts or multicasts video streams associated with available camera views 90. In a multicasting or broadcasting scenario, the streaming server 120 further sends notifications to one or more user equipments indicating which video streams and/or streaming sessions are relavant to the each of the one or more user equipments 130. A user equipment 130 receiving video data in a broadcasting service, decodes only relavant video streams based on the received notifications. A user equipment 130 uses received notifications to decide which multicasting sessions to subscribe to.

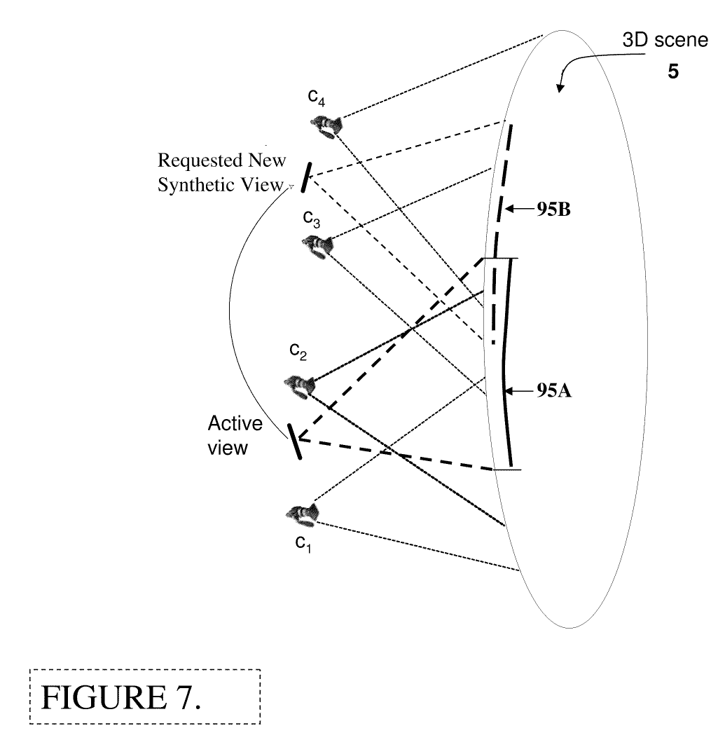

FIG. 7 illustrates an example embodiment of scene navigation from one active view to a new requested view. In the example of FIG. 7, there are four available camera views indexed V1, V2, V3 and V4. The current active view being consumed by the user, according to FIG. 7, is the synthetic view 95A. The user then decides to switch to a new requested synthetic view, e.g., the synthetic view 95B. According to a preferred embodiment, the switching from one view to another is optimized by minimizing the modification in video data streamed from the streaming server 120 to the user equipment 130. For example, the current active view 95A, of FIG. 7, may be constructed using the camera views V2 and V3 corresponding, respectively, to the cameras C2 and C3. The requested new synthetic view 95B may be constructed, for example, using the camera views V3 and V4 corresponding, respectively, to the cameras C3 and C4. The user equipment 130, for example, receives the video streams corresponding to camera views V2 and V3 while consuming the active view 95A.

According to an example embodiment, when switching from the active view 95A to the requested new synthetic view 95B, the user equipment 130 keeps receiving, and/or decoding, the video stream corresponding to the camera view V3. The user equipment 130 further starts receiving, and/or decoding, the video stream corresponding to camera view V4 instead of the video stream corresponding to the camera view V2. In a multicasting scenario, the user equipment 130 subscribes to multicasting sessions associated with the camera views V2 and V3 while consuming the active view 95A. When switching to the camera view 95B, the user equipment 130, for example, leaves the session corresponding to camera view V2 and subscribes to the multicasting session corresponding to camera view V4. The user equipment 130 keeps consuming the session corresponding to the camera view V3. In a broadcasting scenario, the user equipment 130 stops decoding the video stream corresponding to camera view V2 and starts decoding the video stream corresponding to the camera view V4. The user equipment 130 also keeps decoding the video stream corresponding to the camera view V3.

Considering a generic case where the 3D scene is covered using a sparse array of cameras Cᵢ, i={1 . . . N} with overlapping fields of view. The number N indicates the total number of available cameras. The transformations H_{i→j} map each camera view Vᵢ, corresponding to camera Cᵢ, onto another view Vⱼ, corresponding to camera Cⱼ. According to an example embodiment H_{i→j} abstracts the result of all geometric transformations corresponding to relative placement of the cameras and 3D scene depth. For example H_{i→j} may be thought of as a 4 dimensional (4-D) optical flow matrix between snapshots of least one couple of views. The 4-D optical flow matrix maps each grid position, e.g., pixel m=(x, y)^{T}, in Vᵢ, onto its corresponding match, in Vⱼ, if there is overlap between views Vᵢ and Vⱼ at that grid position. If there is no overlap, an empty pointer, for example, is assigned. The 4-D optical flow matrix may further indicate changes, for example, in luminance, color settings and/or the like between at least one couple of views Vᵢ and Vⱼ. In another example, the mapping H_{i→j} produces a binary map, or picture, indicating overlapping regions or pixels of between views Vᵢ and Vⱼ.

According to an example embodiment, the transformations H_{i→j} may be used by, e.g., by the streaming server 120 and/or one or more user equipments 130, in identifying camera views associated with a synthetic view 95. The transformations between any two existing camera views 90 may be, for example, pre-computed offline. The computation of the transformations is computationally demanding and thus pre-computing the the transformations H_{i→j} offline allows efficient and fast streaming of multi-view video data faster and more suitable to be performed offline. The transformations may further be apdated, e.g., while streaming is ongoing, if a change occurs in the orientation and/or settings of one or more cameras 15.

According to an example embodiment, the transformation between available camera views 90 are used, for example, by the multi-view analysis module 123, to identify camera views to be used for reconstructing a synthetic view. For example, in a 3-D scene navigation scenario, denote the view currently being watched by a user equipment 130, e.g., active client view, as Vₐ. The active client view Vₐ may correspond to an existing camera view 90 or to any other synthetic view 95. In the example of FIG. 7, Vₐ is the synthetic view 95A. The correspondences, e.g., H_{a→i}, between Vₐ and available camera views 90 are pre-calculated. The streaming server 120 may further store, for example, transformation matrices H_{a→i} where i={1 . . . N}, or store just indications of the camera views used to reconstruct Vₐ. In the example of FIG. 7, the streaming server may simply store indication of the camera views V₂ and V₃. The user changes the viewpoint by defining a new requested synthetic view Vₛ, for example synthetic view 95B in FIG. 7. The streaming server 120 is informed about the change of view by the user equipment 130. The streaming server 120, for example in a unicast scenario, determines the change in camera views transmitted to the user equipment 130 due to the change in view by the same user equipment 130.

According to an example embodiment, determining the change in camera views transmitted to the user equipment 130 may be implemented as follows: Upon renewed user interaction to change viewpoint,

1. User equipment 130 defines the geometric parameters of the new synthetic view Vₛ. This can be done for example by calculating the boundary area that results from increments due to panning, zooming, perspective changes and/or the like.

2. User equipment 130 transmits defined geometric parameters of the new synthetic view Vₛ to the streaming server.

3. The streaming server calculates the transformations H_{s→i} between Vₛ and the camera views Vᵢ that are used in the current active view Vₐ. In this step, the streaming server identifies currently used camera views that may also be used for the new synthetic view. In the example of FIG. 7, the streaming server calculates H_{s→2} and H_{s→3} assuming that just V₂ and V₃ are used to reconstruct the current active view 95A. In the same example of FIG. 7, both camera views V₂ and V₃ overlap with Vₛ.

4. The streaming server 120 then compares the already calculated matrices H_{s→i} in case any camera views overlapping with Vₛ may be eliminated. In the example of FIG. 7, the streaming server compares H_{s→2} and H_{s→3}. The comparison indicates that overlap region indicated in H_{s→2} is a sub-region of the overlapping region included in H_{s→3}. Thus the streaming server decides to drop the video stream corresponding to the camera view V₂ from the list of video streams transmitted to the user equipment 130. The streaming server 120 keeps the video stream corresponding to the camera view V₃ in the list of video streams transmitted to the user equipment 130.

5. If the remaining video streams, in the list of video streams transmitted to the user equipment 130, is not enough to construct the synthetic view Vₛ, the streaming server 120 continue the process with remaining camera views. In the example of FIG. 7, since V₃ is not enough to reconstruct Vₛ, the streaming server 120 further calculates H_{s→1} and H_{s→4}. The camera view V₁ in FIG. 7 does not overlap with Vₛ, however V₄ does. The streaming server 120 then ignores V₁ and adds the video stream corresponding to V₄ to the list of transmitted vieo streams.

6. If needed, the streaming server performs further comparisons as in step 4 in order to see if any video streams in the list may be eliminated. In the example of FIG. 7, since V₃ and V₄ are sufficient for the reconstruction of Vₛ, and none of V₃ and V₄ is sufficient alone to reconstruct Vₛ, the streaming server finally starts streaming the vieo stream in the final list, e.g., the ones corresponding to V₃ and V₄.

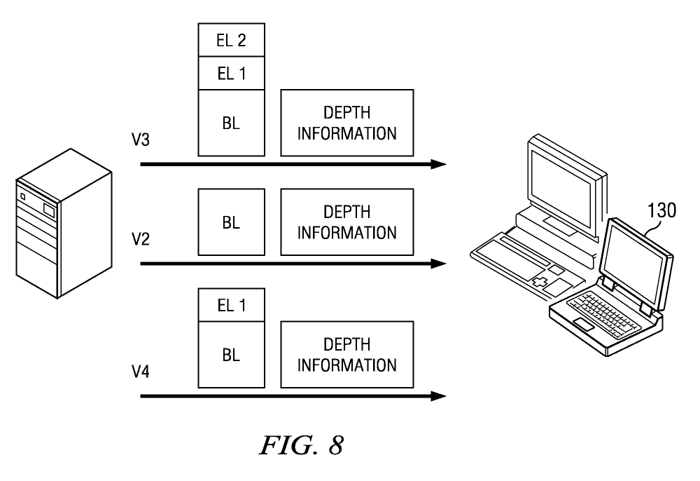

FIG. 8 illustrates an example embodiment of scalable video data streaming from the streaming server 120 to user equipment 130. The streaming server transmits video data associated with the camera views V2, V3 and V4 to the user equipment 130. According to the example embodiment in FIG. 8, the transmitted scalable video data corresponding to the camera view V2 comprises a base layer, a first enhancement layer and a second enhancement layer. The transmitted scalable video data corresponding to the camera view V4 comprises a base layer and a first enhancement layer, whereas the transmitted video data corresponding to the camera view V2 comprises only a base layer. Scene depth information associated with the camera views V2, V3 and V4 is also transmitted as an auxiliary data stream to the user equipment 130. The transmission of a subset of the video layers, e.g., not all the layers, associated with one or more camera views allows for efficient use of network resources.

Without in any way limiting the scope, interpretation, or application of the claims appearing below, it is possible that a technical effect of one or more of the example embodiments disclosed herein may be efficient streaming of multi-view video data. Another technical effect of one or more of the example embodiments disclosed herein may be personalized free view TV applications. Another technical effect of one or more of the example embodiments disclosed herein may be an enhanced user experience.

Embodiments of the present invention may be implemented in software, hardware, application logic or a combination of software, hardware and application logic. The software, application logic and/or hardware may reside on a computer server associated with a service provider, a network server or a user equipment. If desired, part of the software, application logic and/or hardware may reside on a computer server associated with a service provider, part of the software, application logic and/or hardware may reside on a network server, and part of the software, application logic and/or hardware may reside on a user equipment. In an example embodiment, the application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium that may be any media or means that can contain or store the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
a processing unit configured to:
receive information related to available camera views of a three dimensional scene;
request a synthetic view, said synthetic view being different from any available camera view and said synthetic view being determined by the processing unit; and
receive media data comprising video data associated with the synthetic view.

2. An apparatus according to claim 1, wherein the processing unit is further configured to identify one or more camera views associated with the determined synthetic view from said available camera views.

3. An apparatus according to claim 2, wherein identifying the one or more camera views, associated with the requested synthetic view, comprises minimizing the number of identified camera views.

4. An apparatus according to claim 2, wherein the received media data comprises multiple video streams associated with multiple available camera views, the processing unit is further configured to decode only video streams associated with the identified camera views.

5. An apparatus according to claim 2, wherein the processing unit is further configured to subscribe to one or more multicasting sessions for receiving the media data, said one or more multicasting sessions are related to one or more video streams associated with the one or more identified camera views.

6. An apparatus according to claim 2, wherein the processing unit is further configured to:
send information related to the one or more identified camera views to a network server; and
receive, as media data, one or more video streams, corresponding to the one or more identified camera views, in a unicast session.

7. An apparatus according to claim 2, wherein the processing unit is further configured to:
reconstruct the requested synthetic view; and
display the requested synthetic view.

8. An apparatus according to claim 2, wherein the processing unit is further configured to:
send information indicative of the one or more identified camera views and information related to the requested synthetic view to a network server; and
receive, as media data, a video stream, corresponding to the requested synthetic view, in a unicast session, said video stream being constructed based at least in part on the one or more identified camera views and the information related to the requested synthetic view.

9. An apparatus according to claim 1, wherein the processing unit is further configured to:
send information related to the requested synthetic view to a network server; and
receive, as media data, one or more video streams in a unicast session, said one or more video streams being identified by said network server.

10. An apparatus according to claim 1, wherein the processing unit is further configured to:
send information related to the requested synthetic view to a network server; and
receive, as media data, one video stream in a unicast session, said one stream being generated, by said network server, based at least in part on said sent information and video data associated with one or more camera views.

11. An apparatus according to claim 1, wherein the processing unit is further configured to:
send information related to the requested synthetic view to a network server;
receive indication of one or more multicast sessions related to one or more video streams, said one or more video streams being associated with one or more camera views identified by said network server; and
subscribe to the one or more indicated multicasting sessions to receive the one or more video streams associated with the identified one or more camera views.

12. An apparatus according to claim 1, wherein the processing unit is further configured to:
send information related to the requested synthetic view to a network server;
receive indication of one or more video streams, said one or more video streams being associated with one or more camera views identified by said network server;
receive a plurality of video streams in a broadcasting session, said plurality of video streams comprises the indicated one or more video streams; and
decode the indicated one or more video streams.

13. An apparatus according to claim 1, wherein the processing unit is further configured to:
reconstruct the requested synthetic view; and
display the requested synthetic view.

14. An method, comprising:
receiving information related to available camera views of a three dimensional scene, by a user equipment;
determining, at the user equipment, a synthetic view, said synthetic view being different from any available camera view;
requesting by the user equipment, from a communication network, video data associated with the determined synthetic view; and
receiving media data comprising video data associated with the determined synthetic view, by the user equipment.

15-26. (canceled)

27. An apparatus, comprising:
a processing unit configured to:
send information related to available camera views of a three dimensional scene;
receive, from a user equipment, request for a synthetic view, said synthetic view being different from any available camera view; and
transmit media data, the media data comprising video data associated with siad synthetic view.

28. An apparatus according to claim 27, wherein the transmission of media data comprises transmitting video streams associated with available camera views in a plurality of multicasting sessions.

29. An apparatus according to claim 27, wherein the processing unit is further configured to:
receive, from said user equipment, information indicative of one or more camera views associated with said synthetic view; and
transmit one or more video streams corresponding to the indicated one or more camera views in a unicast session.

30. An apparatus according to claim 27, wherein the processing unit is further configured to:
receive, from said user equipment, information indicative of one or more camera views associated with said synthetic view;
generate a video stream, corresponding to siad synthetic view, based at least in part on, video streams corresponding to the indicated one or more camera views; and
transmit said generated video stream, corresponding to said synthetic view in a unicast session.

31. An apparatus according to claim 27, wherein the processing unit is further configured to:
identify one or more camera views associated with said synthetic view; and
transmit one or more video streams corresponding to the indicated one or more camera views in a unicast session.

32. An apparatus according to claim 27, wherein the processing unit is further configured to:
identify one or more camera views associated with said synthetic view;
generate a video stream, corresponding to said synthetic view, based at least in part on, video streams corresponding to the identified one or more camera views; and
transmit said generated video stream, corresponding to said synthetic view in a unicast session.

33. A method, comprising:
sending information related to available camera views of a three dimensional scene;
receiving, from a user equipment, a request for a synthetic view, said synthetic view being different from any available camera view; and
transmitting media data comprising video data associated with said synthetic view.

34-38. (canceled)

39. A computer program product comprising a computer-readable medium bearing computer program code embodied therein for use with a computer, the computer program code being configured to perform the process of claim 14.

40. A computer program product comprising a computer-readable medium bearing computer program code embodied therein for use with a computer, the computer program code being configured to perform the process of claim 33.
